(19) United States
(12) Patent Application Publication
(10) Pub. No.: US 2013/0262624 A1
(43) Pub. Date: Oct. 3, 2013

(54) Method and System for the Dissemination of the Profiles That a User Has on the Various Online Social Networks

(71) Applicants: Agustin Acebo Ruiz, Madrid (ES); Jose Angel Granado Castano, Toledo (ES)

(72) Inventors: Agustin Acebo Ruiz, Madrid (ES); Jose Angel Granado Castano, Toledo (ES)

(21) Appl. No.: 13/438,132

(22) Filed: Apr. 3, 2012

(51) Int. Cl. G06F 15/16

(52) U.S. Cl. 709/217

(57) ABSTRACT

A method and system for the dissemination of the profiles that a user has on the various online social networks, based on recognising a physical element and network software allowing any user of online social networks to disseminate all or part of the profiles they have on the various online social networks to which they belong effectively and selectively, based on identification of users via a string of graphic symbols.

A method and system for the dissemination of the profiles that a user has on the various online social networks based on a physical element and network software.

### OBJECT OF THE INVENTION

The invention herein relates to the field of social networks and is a method that allows the dissemination of the profiles that a user has on the various online social networks.

The method according to the invention herein makes it possible for any user of online social networks to efficiently and selectively disseminate all or part of the profiles he/she has on the various online social networks to which he/she belongs, based on the image of physical element and a networked computer system.

The computer system which forms part of this method consists of network software, a server and database, which stores information on registered users, such as the username and the profiles that each user has on the various online social networks. A user can enter their username and social network profiles to which they belong by using the system software and these are then stored in the database.

The username for each user will be composed of a combination of graphic symbols or a combination of graphic symbols and computer characters (grapheme) but never exclusively by a combination of computer characters.

The image of the physical element, which forms part of this method, is the material representation of a registered user's user name. It is designed to be borne by the registered user and will identify the bearer as a registered user of the system. Generally it will comprise a fashion item such as a pin badge, bracelet, pendant, key ring or similar embodiment.

The system allows a user to be identified as a registered user of the system by other users who are viewing him/her personally, in a photograph, on a video, etc., via the physical element being borne and which forms part of this method and represents his/her registered system username. Thus, any user can find the profiles that this user has registered on social networks by entering the user name (embodied in the physical element) of the registered user into the system software and the latter automatically displays the social network profiles for the name of the registered user entered.

### BACKGROUND OF THE INVENTION

Online social networks are social structures composed of groups of people, who are connected by one or more types of relationships, such as friendship, kinship, common interests or shared knowledge.

Social network analysis examines this social structure by applying the graph theory and identifying the entities as “nodes” and the contacts as “links”. The resulting graph structure is often very complex and consequently the number of links between the different nodes can be virtually unlimited.

In its simplest form, a social network is a map of all the relevant links between all nodes studied. “Sociocentric” or “complete” networks are being referred to in this case. Another option is to identify the network that involves a person (in the various social contexts in which they interact), in which case this would be a “personal network”.

Online social networks have been widely established. There are many types of social networks, the objective of a particular group of them is to connect relevant people with their followers, such that these networks become the main mechanism for communicating, relating and connecting between them. Other examples of this type of relationship in social networks are those that occur between brands and consumers, professionals and their clients, athletes and fans, politicians and supporters, artists and the public, journalists and their audience or between activists and the masses, etc.

These networks have reached such a level of implementation that they are accepted as the benchmarks that measure the popularity of the relevant figures depending on the number of followers and fans that they have on such networks and today, this popularity is of enormous value, almost the same or more, in some cases, as their professional activity undertaken by these persons, since it indicates the impact a person can generate for brand names.

Examples of such situations in which relevant people try to promote their social network profiles can be seen with motorcycle riders, soccer teams, television journalists, slogans and banners, etc.

On the contrary, the interest from the relevant people in promoting their social network profiles can be frustrating due to the lack of effective mechanisms for this purpose.

Nonetheless, these persons are permanently interested in promoting their social network profiles, aware of the very valuable wasted promotional opportunities, such as their media appearances, because there are no systems that enable such effective and smart dissemination.

In addition, social networks are increasingly specialized, with new initiatives tailored to increasingly specific situations emerging. As such, the number of social networks is growing permanently and consequently the number of social networks in which the relevant figures are interested in disseminating information is further growing. This makes it difficult to disseminate all of them.

Systems and methods that integrate all the profiles that a user has on social networks in one place are widely known in the state of the art, but these initiatives are not designed to disseminate information they incorporate mainly because user names are generally too long and complex for use as an element of differentiation in a method of dissemination.

### DESCRIPTION OF THE INVENTION

The method and system for the dissemination of the profiles that a user has on the various online social networks based on a physical element and network software, resolves the aforementioned drawbacks by further providing additional advantages which will be apparent from the description provided hereinbelow.

The method and system object of the invention herein proposes the use of a user name formed by combining a few graphic symbols, preferably between 2 and 6, chosen from a predefined set of graphical symbols in the system to allow identification of user names which are simple, brief and easily distinguished by other users and look smart when publicly visible.

In addition, given the significant growth in online videos using online video agencies, you tube, etc, whose growth is exponential, more than any other format, any form of promotion should be based on visual perception.

In this respect the invention herein provides advantages over the current state of the art, as it allows any social network user to efficiently and smartly promote their profiles, based on the visual identification of a physical element consisting of a string of graphic symbols or a grapheme, but never by an exclusive combination of computer characters.

It is important to differentiate between a graphic symbol and computer character as that difference is particularly relevant for understanding the method and system object of the present invention. Thus, in computing there is a need to represent characters in all languages.

The objective of a computer character set is a computer representation of characters in a writing system, so that a user can enter information via the characters in the writing system (glyph) and can further interpret the information processed by the computer and shown via the characters in their writing system (glyph).

Internally, the computer correlates each character in the writing system (glyph) with a sequence of octets, and this relationship is performed via a “code page.”

A computer character set is therefore a relationship between a set of glyphs (marks on paper or a screen that correspond to the letters, numbers, punctuation marks or ideographs in a writing system) and a sequence of octets.

This relationship is internally embodied in a code page included in the computer operating system and its purpose is to establish a correspondence between the characters in a writing system (glyphs) and a series of octets.

An example of a computer character set would be UCS (Universal Character Set), a 31-bit character set that has the capacity to contain, inter alia, the characters of all known languages.

In reality as such a vast processing potential (2³¹) is not necessary, subsets have been defined. An example is B.M.P. (Basic Multilingual Plane) code points and its 2¹⁶ range is sufficient to cover the characters of all known languages.

Outside of this subset (BMP) spaces are reserved for the characters of ancient cultures or characters required by scientists, and spaces shall also be reserved for future requirements.

The user names of users of all existing online social networks are composed of a combination of computer characters, i.e. a combination of glyphs included in a code page belonging to an operating system.

However, the set of symbols comprising the users' registered usernames according to the invention herein refers to a set of images that is not included in any code page of any operating system.

These symbols are a set of graphic files that are not related to any stream of octets in any code page or do not form part of any operating system, in addition, these graphic files contain images that are specified in form, colour, size and other characteristics, unlike the computer characters, which are very generic and do not detail such characteristics.

Having clarified the difference between a symbol and computer character, the username of the users of the method and system according to the invention herein comprises a combination of symbols or a combination of computer symbols and characters but never by an exclusive combination of computer characters.

The system is based on:
1.—A set of graphic symbols predefined in the system that are easy to identify, recognise and memorise, and that should therefore represent specific elements or concepts that are familiar and known, and not abstract images that do not represent any element or concept. Among the symbols available in the system, there will also be several which users can be identified by, such as graphical representations that suggest hobbies, professions, horoscopes, etc.
2.—Strings composed of a subset from the set of graphical symbols that are available in the system. These strings comprising a combination of symbols may include computer characters, i.e. the strings will be composed of a combination of symbols or computer characters and symbols but never exclusively by a combination of computer characters. Symbols forming a string may be repeated within the string. Otherwise the strings will be unrepeatable within the system. The number of symbols and computer characters in the system and the maximum number of elements that the strings can contain defines the total number of possible strings and therefore the maximum number of system users. This number is determined by combinatorial laws, through permutation of X elements taken in groups of Y, wherein X is the maximum number of symbols in the system and Y is the maximum number of symbols in a string. Each user must choose a set of graphic symbols to form a string which is a user's registered user code. Said string may not have been previously chosen by another user; it will be associated to the user who configured it and will exclusively and uniquely identify the user within the system.
3.—A physical element, which is the material embodiment of the string of graphical symbols (FIG. 2). 2). It must be designed to be borne in a visible, natural manner by registered system users. It must therefore be manufactured so it can be assembled on ordinary items, such as a pin badge, a necklace, a bracelet, a watch strap, a cap, etc. This physical element will be chosen by each user; both the string of symbols as well as the format in which said string will be assembled. When each user is registered on the system, a manufacturing order is generated containing the symbols and the selected format in which the string will be assembled. This physical element will subsequently be sent to a distribution centre chosen by the user, where it will be collected and paid on delivery. Creating a registered username can also done electronically, such as for example, an electronic file containing the image of the string of symbols that make up the registered user code and which is used as the background or wallpaper on a mobile phone.
4.—The system according to the invention herein is further based on an networked computer system comprising:
   4.1.—A server containing a hard disk in which an application is implemented comprising a series of interfaces and a programming code that performs a number of functions. It also includes a database. Clients connect to said server via a MODEM and the communications protocol.
   4.2.—Interface-1. New user registration (FIG. 3). Data from a new system user is collected i.e. user name within the system, the string of symbols that the new user wishes to be identified by on the system (FIG. 2), first name and surname(s), the profiles he/she has on the various online social networks and business contact details, such as work e-mail, telephone, business address, photograph, etc., recording this data on an electronic database.
To complete the process of registering a new user, the server sends an e-mail to the address provided by the new user. Said e-mail message contains a link to a URL, which must be clicked on to continue the registration process.
   4.3.—An electronic database, whose records contain:
      4.3.1.—The username for each user within the system, formed by the string of symbols chosen by the new user, his/her first name and surname(s).
      4.3.2.—A record for each of the profiles that each user has on the various online social networks.
   4.4.3.—A record for each user that contains his/her business contact details such as his/her telephone number, contact e-mail address, business address, a photograph, etc.
   4.4.—Interface-2 (FIG. 4). Viewing a user's profiles on social networks. Through which system user-1 can enter the string of graphic symbols comprising the registered username of system user-2 and the system displays the social network profiles to which user-2 belongs along with his/her business contact details, which have previously been recorded by user-2 when he/she registered on the system.
This interface contains a text box that can store up to 128 characters. The message entered into this text box by user-1 can be sent to user-2.
   4.5.—Computer programme code that receives data from interface-2 and connects to the database. Part of the interface-2 data is the string of symbols for user-2's registered username, which is listed in the database containing this user's social network profiles and which are thus found by the programming code.
   4.6.—An interface-3, displaying the list of messages sent by a system user, including target user's string of symbols, the date and time sent and the message sent.
   4.8.—Interface-4. That displays the list of messages received by a system user, including the source user's string of symbols, the date and time received and the message sent.
   4.9.—Interface-5. That gives a user who has received a message the option to reject the messages from that user forever or to reply to said message automatically.
   4.9.—Interface-6. That gives a user who has received a message the option to reject the messages from that user forever or to reply to said message automatically.
5.—Computer application implemented on mobile phone or device. That has the same interfaces that are hosted on the server, but in this case they are hosted on the mobile phone. These interfaces have an associated computer code to connect to the server and access the user database to obtain the data required by users, which will return the requested data to the mobile device.

### BRIEF DESCRIPTION OF THE DRAWINGS

To complement the above description and to aid a better understanding of the characteristics of the invention, a detailed description of the preferred embodiment is provided, based on a set of drawings attached to this descriptive memory and including but not limited to the following:

FIG. 1 shows a diagram of the method and system for the dissemination of the profiles that a user has on the various online social networks according to the invention herein.

FIG. 2 shows a possible string of symbols identifying a registered user.

FIG. 3 shows the application user registration screen.

FIG. 4 shows the user profile search screen on different social networks.

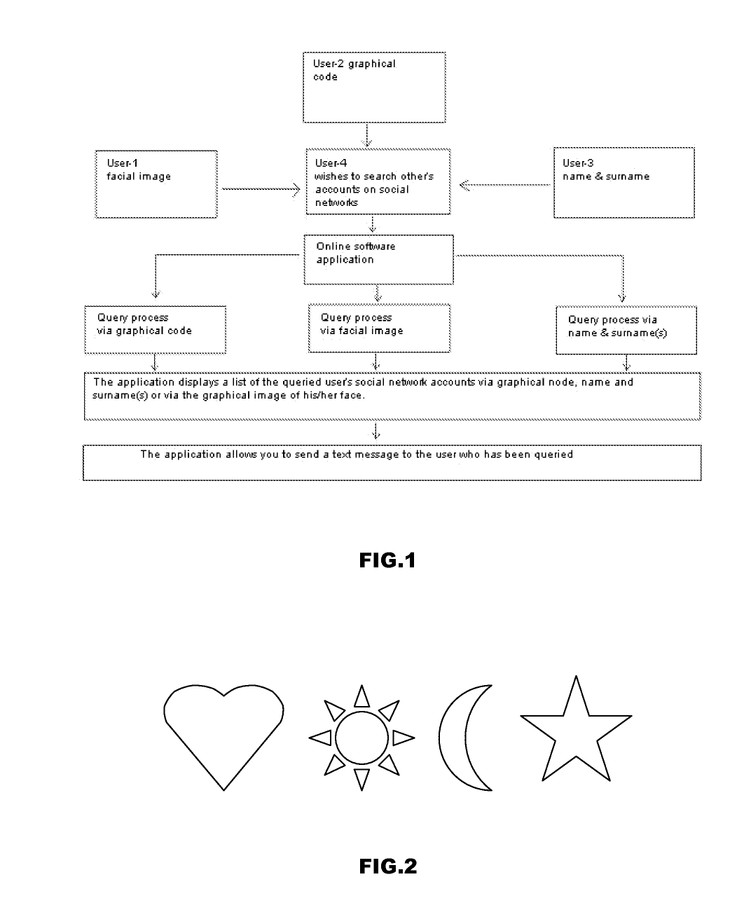

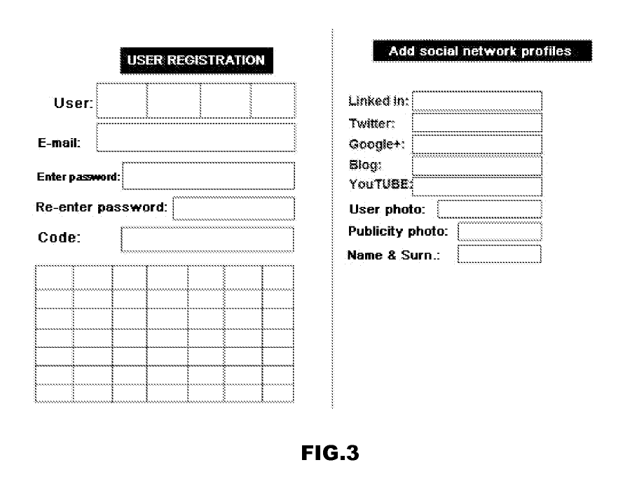

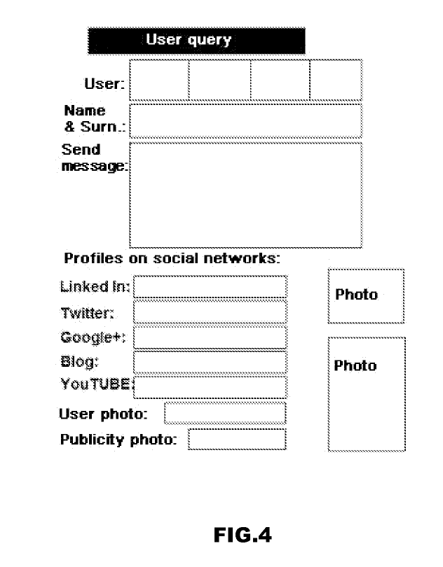

1. A method and system for the dissemination of profiles or accounts that a user has on the various online social networks, based on recognising a physical element and network software comprising a server on which a computer application belonging to the field of social networks is implemented, where registered users are uniquely identified through a combination of symbols and not by the combination of computer characters, a database and at least interfaces for user register, user profile display on social networks, display of messages sent by a user, display of messages received by a user, acceptance or rejection of messages received and a software application implemented on a mobile device.

2. A method and system for the dissemination of the profiles that a user has on the various online social networks, based on recognising a physical element and network software according to claim 1, wherein the software application and database allow a social network user to disseminate all or part of the profiles he/she has on the various online social networks among the people who are viewing, either personally or via a video, photograph, etc., through (other users) distinguishing a physical element borne by the registered user and which is the material representation of his/her registered user name, composed of a string of symbols or computer symbols and characters, and that uniquely identifies him/her within the system, and via a database of registered users which stores a registered user unique identifier for each user, composed of a string of symbols or computer symbols and characters, his/her first name and surname(s), the profiles of the social networks to which this user belongs, his/her personal data and photographs of this user.

3. A method and system for the dissemination of the profiles that a user has on the various online social networks, based on recognising a physical element and network software according to claim 1 wherein each user's username consists of a string of symbols or computer symbols and characters that identifies each registered user uniquely selected by the user among the available strings in the system.

4. A method and system for the dissemination of the profiles that a user has on the various online social networks, based on recognising a physical element and network software according to claim 2 wherein the identification of a user registered in the system occurs via visual identification of his/her string of symbols or unique computer symbols and characters.

5. A method and system for the dissemination of the profiles that a user has on the various online social networks, based on recognising a physical element and network software according to claim 3 wherein the physical element embodying the representation of registered user identifier code unique to each user can be manufactured in different formats, sizes and materials, preferably as a necklace, bracelet, pin badge or other equivalent embodiment.

6. A method and system for the dissemination of the profiles that a user has on the various online social networks, based on recognising a physical element and network software according to claim 3 wherein the registered user unique identifier code can be produced in electronic format, preferably an image of the string of symbols that make up the registered user code and that can be used as the background or wallpaper on a mobile phone.

7. A method and system for the dissemination of the profiles that a user has on the various online social networks, based on recognising a physical element and network software according to claim 2 wherein any registered user can get information about another registered user's social network profiles bearing the perceptible physical element that represents his/her code via a computer system implemented on an Internet server or on a mobile phone.

8. A method and system for the dissemination of the profiles that a user has on the various online social networks, based on recognising a physical element and network software according to claim 7 wherein the computer system or mobile phone application consists of a graphical interface where a registered system user's username is entered.

9. A method and system for the dissemination of the profiles that a user has on the various online social networks, based on recognising a physical element and network software according to claim 7 wherein the computer system consists of an application implemented on an internet server that connects the graphic interface with a database containing registered users data (strings of symbols that identify them uniquely within the system, their business contact details and profiles they have on the various online social networks) obtaining business contact details and profiles on the user's social networks contained on the graphic interface and shows the social network profiles and business data on a new graphical interface designed for this purpose.

10. A method and system for the dissemination of the profiles that a user has on the various online social networks, based on recognising a physical element and network software according to claim 9 wherein there is a space designed to host advertising for each user on said graphical interface.

11. A method and system for the dissemination of the profiles that a user has on the various online social networks, based on recognising a physical element and network software according to claim 9 wherein there is a box text with a capacity for up to 128 characters where text can be entered and sent to the user that is displaying on the system on the graphical interface.

12. A method and system for the dissemination of the profiles that a user has on the various online social networks, based on recognising a physical element and network software according to claim 9 wherein there is a button that automatically incorporates the user displayed into a user diary, where user data is stored such as user name, photograph, first name, etc. on the graphical interface.

13. A method and system for the dissemination of the profiles that a user has on the various online social networks, based on recognising a physical element and network software according to claim 11 wherein a user has the option to block messages received from all or some users.

14. A method and system for the dissemination of the profiles that a user has on the various online social networks, based on recognising a physical element and network software according to claim 2 wherein it comprises a user search string via the user “name and surname” field, in addition to a “username” search string.

15. A method and system for the dissemination of the profiles that a user has on the various online social networks, based on recognising a physical element and network software according to claim 2 wherein it comprises a user search string via the “user photo” graphic field, which identifies the user via an image recognition programme, whose image coincides with the searched image, displaying the data for that user.
